(19) United States
(12) Patent Application Publication
(10) Pub. No.: US 2026/0356634 A1
(43) Pub. Date: Nov. 12, 2026

(54) STAIRLIFT PROVIDING SUPPORT FOR A USER

(71) Applicant: TK HOME SOLUTIONS B.V., Krimpen aan den lJssel (NL)

(72) Inventors: Cornelis Boxum, GV Delfgauw (NL); Wim Heijns, Kinderdijk (NL)

(21) Appl. No.: 19/491,997

(22) PCT Filed: Jun. 21, 2024
(86) PCT No.: PCT/EP2024/067436

§ 371 Date: Dec. 10, 2025

(30) Foreign Application Priority Data
Jun. 28, 2023 (EP) 23181934.3

(51) Int. Cl. B66B 9/08; B66B 3/00; B66B 5/00

(52) U.S. Cl. CPC B66B 9/08; B66B 3/002; B66B 5/0025

(57) ABSTRACT

The present disclosure relates to a stairlift including a guide device, a carriage, a user interaction device for operating the stairlift, at least one loudspeaker, a control unit, and a request receiving device, wherein the control unit is configured to output an operation-status of at least one part of the stairlift and/or at least one instruction to the person, respectively as a voice spoken message by the at least one loudspeaker before, during and/or after operation of the stairlift upon a request received via the request receiving device. The present disclosure further refers to methods to support a user of the stairlift during boarding or unboarding the carriage or during movement of the carriage.

### CROSS REFERENCE TO RELATED APPLICATIONS

This application is the U.S. National Stage of PCT/EP2024/067436 filed on Jun. 21, 2024, which claims priority to European Patent Application 23181934.3 filed on Jun. 28, 2023, the entire content of both are incorporated herein by reference in their entirety.

### TECHNICAL FIELD

The present disclosure generally relates to a stairlift for transporting a person along a staircase, and more specifically to methods to support a user of the stairlift during boarding or unboarding the carriage and during operation of the carriage.

### BACKGROUND

Stairlifts are known from the state of the art. With such, persons unable to use a staircase, e.g. due to disability or certain conditions, are transported along the staircase between a lower and an upper landing position and/or intermediate landing positions, while the staircase is still fully usable for other persons in its usual sense. Such stairlifts have guide means like a rail, on which the carriage is moved, e.g. by a drive unit connected to the guide means. A carriage for a stairlift usually is a chair with a seat, arm rests and/or foot rests, all of which may be foldable to allow other persons to use the staircase without the stairlift. Stairlifts are mostly retrofitted with already existing staircases.

As transported persons are mostly restricted in their ability to move and/or may be restricted in the use of some of their senses, a high need for simple, understandable and save operation of the stairlift is given. In particular, movement of the carriage and any other behavior of the stairlift should be expectable and simply understandable for the user. Further, safety relevant conditions like the status of a seat belt or the status of any other safety relevant parts of the carriage/stairlift must be properly monitored. Also, with disabled or otherwise limited users, a situation may occur, in which a certain behavior of the user is required to continue operation of the stairlift, wherein the user does not know and does not understand, what to do, so that the operation is jammed.

WO 2020/030899 discloses a stairlift configured to detect a fault and issue to a stairlift user a voice-based output in response to that fault.

JP 2010 070341 A further discloses a stairlift with a body being guided on a guide rail and a chair being mounted on the body via raising means. In order to allow for a comfortable boarding of the chair, the chair can be lowered in the landing positions while the chair is raised during travel in order to avoid collision and allow for a low mounting position of the rail. During raise and lowering of the chair, voice guidance is used.

### SUMMARY

Based on the state of art described above, it is an object of the present disclosure to provide a stairlift, which provides improved expectability and understandability of the behavior of the stairlift, wherein interruptions of the operation of the stairlift are avoided.

This object is solved by the features of the independent claims. Advantageous embodiments are indicated in the dependent claims. Where technically possible, the features of the dependent claims may be combined as desired with the features of the independent claims and/or other dependent claims.

According to a first aspect of the present disclosure, the object is solved by a stairlift for transporting a person along a staircase, including a guide device extending along the staircase, a carriage being moveable along the guide device and configured to carry the person, user interaction device for operating the stairlift by moving the carriage along the guide device, at least one loudspeaker, a control unit and request receiving device, wherein the control unit is configured to output an operation-status of at least one part of the stairlift and/or at least one instruction to the person, respectively as a voice spoken message by the at least one loudspeaker before, during and/or after operation of the stairlift upon a request received via the request receiving device.

The guide device may for example be rails, tracks or the like and may be integrated or retrofitted to the staircase, e.g. at steps of the staircase, e.g. standing on the tread of a number of steps, at a balustrade of the staircase or a wall next to the staircase. They include at least one such rail or track or at least two rails or tracks parallel to each other. In some embodiments, the guide device runs parallel to the slope of the staircase and extend horizontally into landing positions at the lower end, the upper end, or an intermediate position of the staircase.

A carriage is connected to a drive unit which is connected to and guided by the guide device and on which the carriage is mounted in a pivotable manner to allow leveling of the carriage in an upright position when the orientation of the guide device/the drive unit vary. The carriage may be formed as a chair, wherein the chair may include arm rests, footrests, a seat and a seat belt to provide for safe accommodation of the transported person. In a landing position, the chair may turn away from the stairs to allow for pleasant boarding from a floor level.

A carriage may alternatively be a platform to carry a wheelchair, wherein the platform may include balustrades, at least one door in the balustrades and retention devices such as belts, hooks and the like. In the landing position, the platform is approximately leveled with a floor. A drive for moving the carriage along the rail may be received in a drive unit or may be of separate configuration from the carriage while being connected to the carriage with traction or due to integration in the guide means.

The user interaction device may include a joystick, a touchpad, a touchscreen, a button, a remote control or the like any may further be located at the carriage, e.g. at an arm rest or at a balustrade of a platform, and located in at least one landing position, e.g. at a wall or at a balustrade of the staircase, such as a remote control. The interaction device may have an active state and inactive state, which may be associated with a certain position of the interaction device.

A control unit may be a central control unit of the stairlift, which includes a microcontroller or the like. The control unit is further connected to operation device of the stairlift such as a drive, to folding/unfolding-mechanisms, e.g. of arm rests and/or footrests of a chair and/or the seat, to safety related parts such as a seat belt or retaining device and/or to opening/closing-mechanisms of a door in a balustrade of a platform and. The control unit may be of an integrated form, wherein all its parts/functions are integrated in a single entity but may also include different entities connected with each other for interaction. Accordingly, the loudspeaker may be integrated in the control unit or may be formed separate from the control unit. Different entities of the control unit may be associated to the carriage or to a landing position.

Within the description and the claims, the terms “person” and “user” are used interchangeable and describe a person interacting with the stairlift in some way. The specific terms are used as best fit in a particular context, wherein “person” mostly refers to the transportation as such and “user” mostly refers to a/the person interacting with the stairlift before, during or after operation.

An operation status is understood as the progress of an operation of the stairlift taking place or being about to take place. This operation may be e.g. the arrival or departure of the carriage at a landing position, the folding or unfolding of any part of the stairlift/carriage, the opening of a door in a balustrade of a platform. An operation may include steps which are processed after each other, e.g. boarding of a user may include unfolding a seat of the chair of the carriage, unfolding an armrest of the carriage, unfolding a footrest of the carriage, wait for the user being seated and have his arms and legs rested on the rests, wait for the seat belt to be fastened and proceed to departure operation. In this case, the operation-status may include information on which step/s has/have already been processed and which step/s is/are about to be processed next. An operation may on the other hand be continuous like in the case of the carriage approaching a landing position. In this case, the operation-status may include information on the remaining travel time or the remaining travel distance or the like. The operation status refers exclusively to a regular operation of the stairlift unrelated to a fault or emergency condition. An operation may have certain requirements to begin, in particular requirements regarding safety conditions.

Within the description, the operation-status is referred to regarding a specific part of the stairlift or in general, wherein it is to be understood, that an operation includes operations of several parts and the operations of the several parts together form the general operation.

A voice spoken message is understood as a playback of spoken words, for example of a prerecorded voice, wherein single words may be prerecorded to build sentences or statements from these prerecorded word or entire sentences or statements may be prerecorded. In an alternative example, the words or sentences/statements are generated by an AI or otherwise artificial and are not prerecorded. A certain voice spoken message of a specific content is chosen according to an operation-status by the control unit and is played back via the loudspeaker, when this operation-status is arrived or when the playback is otherwise triggered by the control unit.

According to the technical teaching of the present disclosure, by the voice spoken messages, either the operation of the stairlift is explained to a user in regards to have the user aware and/or in order to have the user behave in a certain way in response to the requested operation. Such an operation status voice spoken message may e.g. be “stairlift arriving/departing”, “seat/chair unfolding/folding”, “armrest unfolding/folding”, “footrest unfolding/folding”, “ready for boarding”, “ready for unboarding”, “approaching corner” or the like. Alternative, the voice spoken message is directed to instruct the user in order to have the user behave in the instructed way. By this, the behavior of the staircase is understandable and expectable for the user and/or it is assured, that the behavior of the user is compatible with the planned or ongoing operation of the stairlift and that potentially hazardous situations are avoided. Further, operation requirements which need to be fulfilled by the user, in particular regarding safety conditions, and which may be forgotten by the user, can be provoked to assure conditions for following operation steps. Such an instruction voice spoken message may e.g. be “please fold/unfold chair/seat/armrest/footrest”, “please put your feet on the footrest”, “please fasten the seat belt”, “please open/close door”, “please hold fast for beginning operation” or the like. Thus, by the present disclosure, the operation of the stairlift is facilitated and the understanding of the user is increased in favor of a positive user experience. Also, expectations of the user are manipulated to comply with the actual behavior of the stairlift.

By outputting the operation-status and/or the instruction to the person upon a request received via the request receiving device, the user can advantageously indicate whether he needs information on the operation-status and/or instructions and mandatory voice spoken messages can be reduced in their number or even be waived in order to avoid them being experienced as intrusive. Further, by requesting the operation-status and/or the instructions via the request receiving device, a voice spoken message may be repeated in case the user did not fully understand it upon before mandatory or requested playback.

As an example, when the user is seated in the carriage, has his arms rest on the arm rest and his feet rest on the footrest and he uses the user interaction device for moving the carriage but the carriage does not move, he can use the request receiving device to request an operations-status or instructions. Upon the request, a voice spoken message is output “seat belt is open” or “please fasten seat belt for operation”. Thus, due to the voice spoken message, the user can realize what behavior he needs to follow to facilitate operation of the stairlift.

In one embodiment, the at least one part of the stairlift is the carriage, an chair, an arm rest, a foot rest, a seat or a seat belt. These are the parts which the user mostly interacts with during boarding and unboarding, and which are mostly effected by the users behavior to fulfil conditions for the following operation (steps). Further, as directly related to the accommodation of the user, these parts do effect safety requirements and safety conditions.

In one embodiment, a voice spoken message may further be output in case of an error, a fault or a potential danger recognized by the stairlift, all of which is subsumed into the term “fault”. Thus, the control unit is then configured to output at least one notice of the fault as a voice spoken message by the at least one loudspeaker upon detection of the fault. E.g. the stairlift includes at least one device for detection of faults such as a collision sensor, a weight sensor, an acceleration sensor, a battery status sensor. Upon detection of a fault by the at least one device, the control unit may output an according voice spoken message via the at least one loudspeaker. By outputting the voice message, a user may become aware of the fault and behave accordingly. Also, the fault situation and the reason for the fault can be understood by the user.

In an embodiment, a first loudspeaker is located at the carriage, a second loudspeaker is located at the lower landing position, a third loudspeaker is located at the upper landing position and/or a fourth loudspeaker is located at an intermediate landing position. Thus, no matter at which position the user is, he can properly hear and understand the voice spoken message and the stairlift is therefore simple, comfortable, and safe to use.

The request receiving device are provided for manual operation, and may include at least one button, at least one lever or at least one touch-sensitive display. In this case, the request receiving device may be located at the carriage but may also be located at any of the landing positions. The device for manual operation are intuitive and simple in use, for users with disabilities or other limitations.

In another embodiment, the request receiving device is provided for voice command operation, such as at least one microphone. The request receiving device is connected to the control unit, wherein the control unit is configured to receive and process according voice commands. By voice commands, the request may be received simple and safely, when the user is hindered to use manual operation, e.g. due to disabilities or other limitations. Request receiving device provided for voice command operation are positioned at more than one position in the stairlift to receive voice commands from any potential position of the user. By voice commands, a particular differentiation on the users needs is possible. E.g. the user may say “status” or “please instruct me” to request a generic operation-status or instruction. The user may however also ask a particular question in order to receive a specific information.

The control unit is therefore configured to analyze the voice command received and may include an artificial intelligence in order to recognize different voice commands and their content. The input of voice commands may further be coupled to a specific keyword, wherein voice commands includes the keyword in the beginning for being recognized by the control unit.

In another embodiment, the request receiving device is provided for recognizing a pattern of inputs at the user interaction device or other data within the stairlift. E.g. when the user repeatedly uses the user interaction device without a movement of the carriage, this is interpreted as an request for a voice spoken message on the operation-status of the stairlift.

The first request receiving device are located at the carriage, the second request receiving device are located at a lower landing position, the third request receiving device are located at an upper landing position and/or the fourth request receiving device are located at an intermediate landing position. Thus, no matter in which position around the stairlift the user is located, the user may input a request at one of the request receiving devices.

The stairlift includes at least one sensor to detect the operation-status of the at least one part, which may be connected to the control unit. With these at least one sensor, operation status is monitored and particular voice spoken messages are triggered. E.g. it may be detected that a person is seated by a weight sensor while it is further detected, that the seat belt is not fastened by a seat belt sensor.

The control unit is configured to receive an operation-status of the stairlift by interpreting at least one operation parameter. E.g. when the movement speed of the carriage is zero or becomes zero without the user interaction device being released, it can be interpreted that the carriage is/has arrived at a landing position. As an further example, when the user releases the user interaction device without the stairlift being at a landing position, a voice spoken massage may be triggered wherein the user is instructed to keep on moving the stairlift.

The stairlift includes a storage unit, wherein at least one voice spoken message and/or at least one program to generate voice spoken messages is stored in the storage unit. The storage unit is a non-volatile storage. The stored voice spoken messages or program may be stored in the storage upon installation of the stairlift or at any later time. Depending on an operation-status detected by a sensor or interpreted from at least one operation parameter, a specific one of the stored voice spoken messages may be selected/generated and loaded for replay via the at least one loudspeaker.

According to a second aspect of the present disclosure, the object is further solved by a method to support a user of a predescribed stairlift during boarding or unboarding the carriage, wherein at least one operation-status of at least one part of the stairlift and/or at least one instruction to the user is output as a voice spoken message by the at least one loudspeaker upon a request received via the request receiving device. The advantages predescribed referring to the stairlift do apply to the method respectively. In particular, the operation-status and/or the instruction refer to the carriage and the position of the user on the carriage, including chair position/positioning of the user of the seat of the chair, arm rest position/positioning of the user on the arm rest, foot rest position/positioning of the user on the foot rest and seat belt status or including platform position/positioning of the user on the platform and door status in case of the carriage being a platform. The operations of boarding begins by the arrival of the carriage without a boarded user at a certain landing position or the arrival of the user at a landing position where the carriage is waiting and ends with the departure of the carriage with a boarded user from the landing position, while the operation of unboarding begins by the arrival of the carriage with a boarded user at a certain landing position and ends with the user leaving the landing position from the carriage.

According to a third aspect of the present disclosure, the object is further solved by a method to support a user of a predescribed stairlift during movement of the carriage, wherein at least one operation-status of at least one part of the stairlift and/or at least one instruction to the user is output as a voice spoken message by the at least one loudspeaker upon a request received via the request receiving device. The advantages predescribed referring to the stairlift do apply to the method respectively. In particular, the operation-status and/or the instruction refer to the movement of carriage, including departure/arrival of the carriage at/from a landing position, acceleration/deceleration and approaching of a corner or any other obstacle.

### BRIEF DESCRIPTION OF THE FIGURES

In the following, the present disclosure is explained in more detail with reference to the accompanying figures using preferred examples of embodiments. The formulation figure is abbreviated in the drawings as fig.

FIG. 1 is a view of a stairlift according to an aspect of the invention;

FIG. 2 is a schematic view of components of the stairlift according to FIG. 1; and

FIG. 3 is a method diagram of a method according to an aspect of the invention

FIG. 4 is a method diagram of a method according to an aspect of the invention.

### DETAILED DESCRIPTION

The described embodiments are merely examples that can be modified and/or supplemented in a variety of ways within the scope of the claims. Any feature described for a particular embodiment example may be used independently or in combination with other features in any other embodiment example. Any feature described for an embodiment example of a particular claim category may also be used in a corresponding manner in an embodiment example of another claim category.

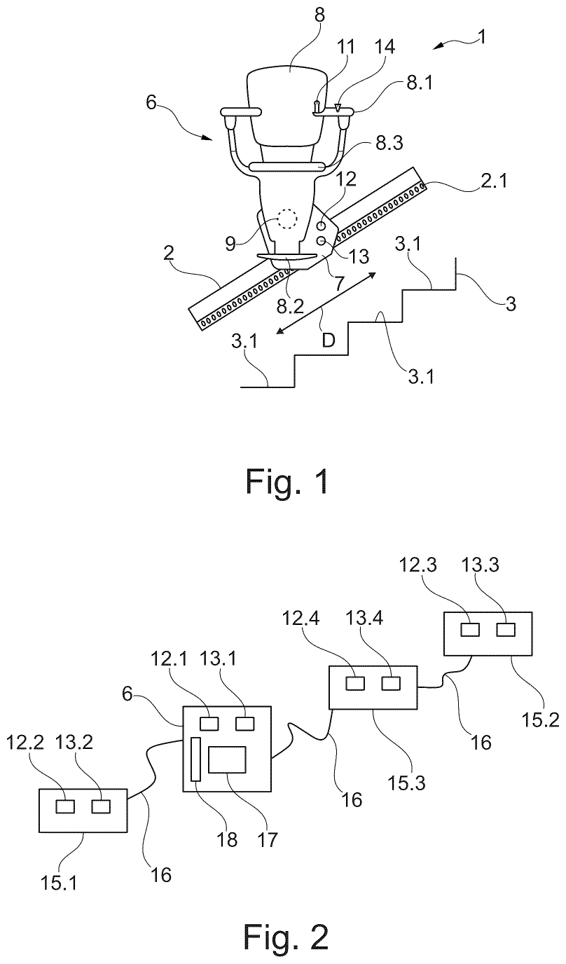

FIG. 1 shows a stairlift 1 according to the first aspect of the present disclosure. The stairlift 1 includes guide device 2 formed as a rail and running parallel to the slope of a staircase 3 in a direction D, wherein the staircase 3 has a number of steps 3.1. The stairlift 1 further includes a carriage 6, which can move along the guide device 2 in the direction D, and which includes a drive unit 7 and a chair 8, wherein the chair 8 is connected to the drive unit 7 in a pivotable manner by a leveling mechanism 9. For driving the carriage 6, positive engagements means 2.1 are provided on the guide device 2, which cooperate with driving means (not shown), in particular a driven pinion, of the drive unit 7.

The guide device 2 can have a curved shape, which deviates from a straight line; thus the direction of travel and/or the inclination of the guide means 2 may change at least once during the course of the guide device 2 and the guide device 2 may run out horizontally at a landing position 15.1, 5.2, 15.3, wherein the chair 8 is hold in an upright position due to the leveling mechanism 9.

The chair 8 includes arm rests 8.1, a footrest 8.2 and a seat 8.3 and user interaction device 11 in the form of a joystick. By pulling the user interaction device 11 to a corresponding side, the carriage 6 may be driven to the according side in the direction D. The user interaction device 11 is pictured in an upright position which is associated to an active state, while they might be folded, e.g. into a recess at the arm rest 8.1, to get deactivated.

The carriage 6 further includes a loudspeaker 13, which is exemplarily located at the drive unit 7 but may be located at any other part of the carriage 6 and which is configured to output voice spoken messages, e.g. to a user of the stairlift 1, a caretaker or a technician. The carriage 6 further includes request receiving device 12 provided as a microphone, which are exemplarily located at the drive unit 7 but may be located at any other part of the carriage 6 and which is configured to receive voice commands, e.g. from a user of the stairlift 1, a caretaker or a technician. The carriage 6 further includes a request receiving device 14 provided as a button on the arm rest 8.1 for manual operation. The loudspeaker 13 and the request receiving device 12, 14 are connected to a control unit 17, that processes voice spoken messages and or voice commands, wherein the control 17 unit is not pictured in FIG. 1.

FIG. 2 shows an abstract drawing of the stairlift 1, wherein a carriage 6, a lower landing position 15.1, an upper landing position 15.2 and an intermediate landing position 15.3 are connected with each other by connection devices 16, e.g. by cables or wireless connection. While at the carriage 6, a first loudspeaker 13.1 and first request receiving device 12.1 are located, a second loudspeaker 13.2 and second request receiving device 12.2 are located at the lower landing position 15.1, a third loudspeaker 13.3 and third request receiving means 12.3 are located at the upper landing position 15.2 and a fourth loudspeaker 13.4 and fourth request receiving device 12.4 are located at the intermediate landing position 15.3.

Upon arrival at a certain operation-status, a voice spoken message is output via one or more of the loudspeakers 13, 13.1, 13.2, 13.3, 13.4 depending on whether the position of a user is received at the control unit 17. This is, the control unit 17, which is located at the carriage 6 and is connected to the landing positions 15.1, 15.2, 15.3 via connection devices 16, processes the voice spoken message upon a certain trigger, e.g. at a certain operation-status, at a certain time or upon request via the request receiving devices 12, 12.1, 12.2, 12.3, 12.4, 14. The voice spoken message is therefore loaded from a storage unit 18. Such a voice spoken message may e.g. include the operation-status and/or an instruction to the user of the stairlift 1 on how to use/board/unboard/operate the stairlift 1, an information about the before standing behavior of the stairlift 1 for convenience of the user or a warning or information regarding a fault.

While with the first request receiving device 12.1, voice commands may be received at the carriage 6, with the second request receiving device 12.2, voice commands may be received at the lower landing position 15.1, with the third request receiving device 12.3, voice commands may be received at the upper landing position 15.2 and with the fourth request receiving device 12.4, voice commands may be received at the intermediate landing position 15.4. Any of these voice commands are transmitted to the control unit 17 via connection devices 16. If a voice spoken message is requested via a request receiving devices 12, 12.1, 12.2, 12.3, 12.4, 14, the control unit 17 may recognize the specific request receiving devices 12, 12.1, 12.2, 12.3, 12.4, 14 and sent the voice spoken message to the according loudspeakers 13, 13.1, 13.2, 13.3, 13.4 associated with the position of the specific request receiving devices 12, 12.1, 12.2, 12.3, 12.4, 14.

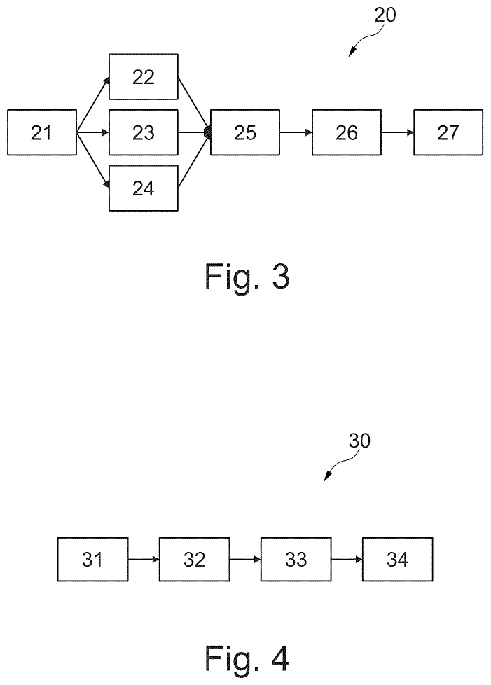

Now referring to FIG. 3, a method 20 to support a user of a stairlift 1 during boarding includes arrival of the empty and completely folded carriage 6 at a landing position 15.1, 15.2, 15.3 in a first step 21. In a second step 22, the seat 8.3 is unfolded from its folded position. In a third step 23, the arm rest 8.1 is unfolded from its folded position. In a fourth step 24, the foot rest 8.2 is unfolded from its folded position. In a fifth step 25, seating of the user on the seat 8.3 is verified via a weight sensor not pictured in the figures. If the presence of the user on the seat 8.3 is recognized via the weight sensor, a voice spoken message is output in a sixth step 26, wherein the user is instructed to close a seat belt not pictured in the figures. After the seat belt is recognized to be closed by a seat belt sensor not pictured in the figures, the carriage departs from the landing position 14.1, 14.2, 14.3 in a seventh step 27. Now referring to FIG. 4, a method 30 to support a user of a stairlift 1 during movement of the carriage 6 includes departure of the carriage 6 with the user boarded from a landing position 15.1, 15.2, 15.3 in a first step 31. In a second step 32, an obstacle, e.g. a corner in the guide device 2 is recognized by a sensor not pictured in the figures. In a third step 33, a voice spoken message is output, wherein the user is e.g. instructed to hold fast for the upcoming corner or informed about the upcoming deceleration. In a fourth step 34, the obstacle is passed.

1. A stairlift for transporting a person along a staircase, comprising:
a guide device extending along the staircase;
a carriage being moveable along the guide device and configured to carry the person;
a user interaction device for operating the stairlift by moving the carriage along the guide device;
at least one loudspeaker;
a control unit; and
at least one request receiving device;
wherein the control unit is configured to output an operation-status of at least one part of the stairlift or at least one instruction to the person, respectively as a voice spoken message by the at least one loudspeaker before, during and/or after operation of the stairlift upon a request received via the at least one request receiving device.

2. The stairlift according to claim 1, wherein the at least one part of the stairlift is the carriage, a chair, an arm rest, a foot rest, a seat or a seat belt.

3. The stairlift according to claim 1, wherein the control unit is configured to output at least one notice of a fault as a voice spoken message by the at least one loudspeaker upon detection of the fault.

4. The stairlift according to claim 1, wherein a first loudspeaker of the at least one loudspeaker is located at the carriage, a second loudspeaker of the at least one loudspeaker is located at a lower landing position, a third loudspeaker of the at least one loudspeaker is located at an upper landing position or a fourth loudspeaker of the at least one loudspeaker is located at an intermediate landing position.

5. The stairlift according to claim 1, wherein the at least one request receiving device is provided for manual operation, the at least one request receiving device is at least one button, at least one lever or at least one touch-sensitive display.

6. The stairlift according to claim 1, wherein the at least one request receiving device is at least one microphone configured for voice command operation.

7. The stairlift according to claim 1, wherein a first request receiving device of the at least one request receiving device are located at the carriage, a second request receiving device of the at least one request receiving device are located at a lower landing position, a third request receiving device of the at least one request receiving device are located at an upper landing position or a fourth request receiving device of the at least one request receiving device are located at an intermediate landing position.

8. The stairlift according to claim 1 further comprising:
at least one sensor to detect the operation-status of the at least one part of the stairlift.

9. The stairlift according to claim 1, wherein the control unit is configured to receive an operation-status of the stairlift by interpreting at least one operation parameter.

10. The stairlift according to claim 1, further comprising:
a storage unit, wherein at least one voice spoken message or a program to generate voice spoken massages is stored in the storage unit.

11. A method to support a user of a stairlift according to claim 1 during boarding or unboarding the carriage, wherein at least one operation-status of at least one part of the stairlift or at least one instruction to the user is output as a voice spoken message by the at least one loudspeaker upon a request received via the at least one request receiving device.

12. A method to support a user of a stairlift according to claim 1 during movement of the carriage, wherein at least one operation-status of at least one part of the stairlift or at least one instruction to the user is output as a voice spoken message by the at least one loudspeaker upon a request received via the request receiving device.
